(19) United States
(12) Patent Application Publication
(10) Pub. No.: US 2021/0216889 A1
(43) Pub. Date: Jul. 15, 2021

(54) Predicting Worksite Activities of Standard Machines Using Intelligent Machine Data

(71) Applicant: Caterpillar Inc., Peoria, IL (US)

(72) Inventors: Eric James Spurgeon, Washington, IL (US); Bradley Keith Bomer, Pekin, IL (US); Tyler Patrick Jewell, Chicago, IL (US)

(73) Assignee: Caterpillar Inc., Peoria, IL (US)

(21) Appl. No.: 16/738,986

(22) Filed: Jan. 9, 2020

(51) Int. Cl. G06N 5/04; G07C 5/00; G06N 20/00; E02F 9/26

(52) U.S. Cl. CPC G06N 5/04; E02F 9/261; G06N 20/00; G07C 5/008

(57) ABSTRACT

A set of machines can be deployed on a construction site or other worksite. The set of machines can include an intelligent machine and one or more standard machines. The intelligent machine can report location and activity data to an off-board computing system, while the standard machines can report location data to the off-board computing system. The off-board computing system can train a machine learning model based on the location and activity data from the intelligent machine, such that that the machine learning model can use location data about the standard machines to predict activities performed on the worksite by the standard machines.

### TECHNICAL FIELD

The present disclosure relates to systems and methods for tracking activities of machines on a worksite and, more particularly, to using location data and activity data from at least one intelligent machine on the worksite to determine activities performed by standard machines on the worksite based on location data corresponding to the standard machines.

### BACKGROUND

As work occurs on a worksite, such as a construction site, many different machines may be present on the worksite. However, due to the nature of the work that can occur on worksites, the number and arrangement of machines on the worksite may change dynamically as work progresses. For example, machines for different purposes may be added or removed from the worksite as work progresses and different types of tasks are performed as part of a dynamic work pattern. Additionally, individual machines may move around the worksite before, during, or after work is performed on the worksite. Accordingly, it can be difficult for worksite managers to track which machines and assets are present on a worksite at any particular time, where such machines and assets are located on the worksite, whether such machines and assets are in use, and/or what activities such machines and assets may be engaged in.

In some systems, each individual machine on a worksite can have a set of sensors that can be used to track and/or report the machine's location and operational parameters. For example, European Patent Application Pub. No. EP2587419 to Horne (hereinafter “Horne”) describes a monitoring system in which a single machine can be provided with a Global Positioning System (GPS) sensor or other location sensor, as well as numerous other sensors that can detect engine speeds, fuel levels, fuel efficiency, positions of machine components, idle and working times, and other machine state parameters. However, although sets of sensors for individual machines in existing systems, for instance as described by Horne, may be useful in tracking the activities and states of the individual machines, it can be costly to provide a full set of sensors for every machine on a worksite. It can also be difficult and time-intensive to maintain a full set of sensors for every machine on a worksite, especially because such sensors may be prone to failure and/or being damaged in harsh work environments. Additionally, such existing systems may not be able to track operations of a set of machines on a worksite unless each of the machines in the set includes a full set of sensors.

The example systems and methods described herein are directed toward overcoming the one or more of the deficiencies described above.

### SUMMARY

According to a first aspect, a system can include an intelligent machine at a worksite, at least one standard machine at the worksite, and an off-board computing system. The intelligent machine can have a first location sensor and a sensor kit, and the at least one standard machine can have a second location sensor. The off-board computing system can receive an activity report associated with the intelligent machine, the activity report including first location data from the first location sensor and activity data based on sensor data from the sensor kit. The off-board computing system can train a machine learning model based on the first location data and the activity data. The off-board computing system can also receive at least one location report associated with the at least one standard machine, the location report including second location data from the second location sensor. The off-board computing system can generate, using the machine learning model and based on the second location data, predicted activity data corresponding to the at least one standard machine that identifies at least one predicted activity of the at least one standard machine.

According to a further aspect, a system can include one or more processors and memory storing computer-executable instructions. The computer-executable instructions, when executed by the one or more processors, can cause the one or more processors to perform operations. The operations can include receiving an activity report comprising first location data and activity data about an intelligent machine on a worksite, training a machine learning model based on the first location data and the activity data, receiving one or more location reports comprising second location data about one or more standard machines on the worksite, and generating, using the machine learning model and based on the second location data, predicted activity data corresponding to the one or more standard machines that identifies at least one predicted activity of the one or more standard machines.

According to another aspect, a method can include receiving, by a computing system, an activity report comprising first location data and activity data about an intelligent machine on a worksite, and training, by the computing system, a machine learning model based on the first location data and the activity data. The method can also include receiving, by the computing system, one or more location reports comprising second location data about one or more standard machines on the worksite, and generating, by the computing system using the machine learning model and based on the second location data, predicted activity data corresponding to the one or more standard machines that identifies at least one predicted activity of the one or more standard machines.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 depicts an example of a worksite where a set of machines can be deployed.

FIG. 2 depicts an example of an intelligent machine and one or more standard machines on a worksite communicating with an off-board computing system.

FIG. 3 depicts an example system architecture for a computing system.

FIG. 4 is a flowchart illustrating a method for training and using a machine learning model to generate predicted activity data.

### DETAILED DESCRIPTION

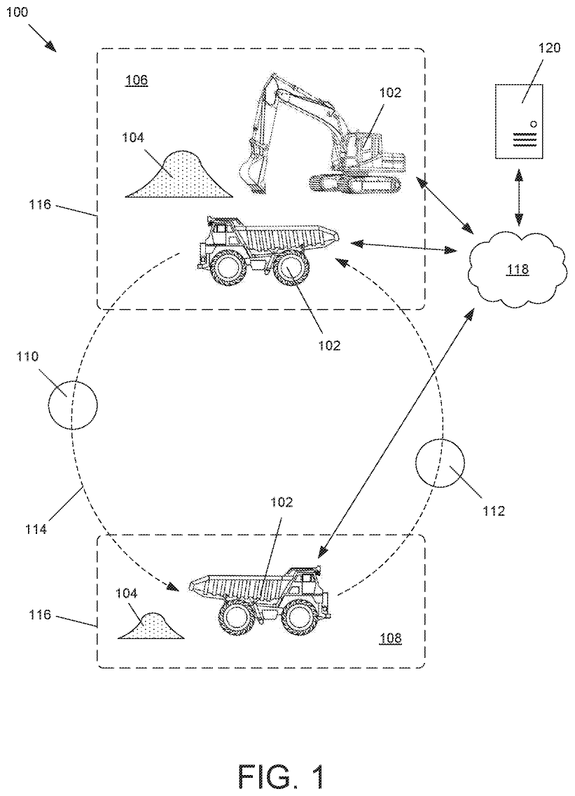

FIG. 1 depicts an example of a worksite 100 where a set of machines 102 can be deployed. A worksite 100 can be a construction site, a mine site, a quarry, or any other type of worksite or work environment where one or more machines 102 can be deployed to perform one or more work tasks. In some examples, a worksite 100 may be considered to be a process site or a project site. In a process site, one or more machines 102 may repeatedly perform a set of tasks. As an example, a process site can be a quarry or a mine site where machines 102 repeatedly move rocks away from a rock face. In a project site, one or more machines 102 may perform different tasks as a project progresses over time. As an example, a project site can be a construction site, a paving site, or other work environment where machines 102 perform different tasks as different stages of construction are reached. In other examples, a worksite 100 may have elements of both a process site and a project site.

A machine 102, as the term is used herein, may refer to a piece of equipment or other asset that is configured to perform one or more types of operations within a worksite 100, between worksites 100, and/or in other environments. For example, a machine 102 can be associated with one or more industries, such as mining, construction, paving, farming, or other industries. Non-limiting examples of machines 102 include commercial machines, such as trucks (e.g., mining trucks, haul trucks on-highway trucks, off-highway trucks, articulated trucks, etc.), cranes, draglines, pipe layers, earth moving vehicles, mining vehicles, backhoes, scrapers, dozers, loaders (e.g., large wheel loaders, track-type loaders, etc.), shovels, material handling equipment, farming equipment, marine vessels, aircraft, and/or any other type of machine that can operate in a work environment. In some examples, more than one type of machine 102 can be present at a worksite 100. In other examples, a worksite 100 can have one or more of machines 102 of the same or a substantially similar type, such as a set of excavators, a set of dump trucks, or other sets of similar types of machines.

Machines 102 deployed on a worksite 100 may be manned machines, autonomous machines, and/or semi-autonomous machines. Human operators may operate, control, or direct some or all of the functions of manned or semi-autonomous machines. However, in examples in which machines 102 are autonomous or semi-autonomous, the speed, steering, work tool positioning/movement, and/or other functions of the machines 102 may be fully or partially controlled automatically or semi-automatically by on-board or off-board controllers or other computing devices, such as computing devices with processors executing computer-readable instructions configured to control the machines 102 autonomously or semi-autonomously.

Machines 102 can be configured to transport or otherwise manipulate material 104 on the worksite 100, such as dirt, rocks, gravel, construction material, and/or any other type of material. For example, a machine 102 can be an excavator that can dig and/or move around dirt or other material 104 at a worksite 100, load material 104 onto a truck or other machine 102, and/or unload material 104 from a truck or other machine 102. As another example, a machine 102 can be a truck or other machine that delivers material 104 to a worksite 100, removes material 104 from a worksite 100, and/or transports material 104 between different areas of a worksite 100.

As discussed above, machines 102 on a worksite 100 may perform a variety of tasks. In some examples, machines 102 can repeatedly perform a set of tasks associated with segments of a work cycle. For instance, an example work cycle can include a loading segment, a loaded transit segment, an unloading segment, and an unloaded transit segment. Such an example work cycle is shown in FIG. 1, where a machine 102 can be loaded with dirt or other material 104 at a loading zone 106 within the worksite 100, the machine 102 can transport the material 104 from the loading zone 106 to a separate delivery zone 108 within the worksite 100, the machine 102 can unload the material 104 at the delivery zone 108, and the machine 102 can then travel back to the loading zone 106 to be loaded with more material 104 for a next iteration of the work cycle.

In some examples, a machine 102 may load and/or unload material 104 by itself during one or more segments of a work cycle. However, in other examples, one or more other machines 102 may load and/or unload material 104 for a machine 102 during a work cycle. For instance, an excavator or other loading machine can be positioned at a loading zone 106 and be configured to load material 104 onto trucks, which can then transport the material 104 to one or more delivery zones 108. In some examples, such trucks may themselves dump or otherwise deliver the material 104 at delivery zones 108. However, in other examples, another excavator or other type of unloading machine can be positioned at a delivery zone 108 to unload material 104 from trucks.

More than one machine 102 may follow the same work cycle on a worksite 100. For instance, in the example shown in FIG. 1, a first truck can be being loaded with material 104 at the loading zone 106 at the same time a previously-loaded second truck is unloading material 104 at a delivery zone 108. Similar trucks already loaded with material 104 may be in transit from the loading zone 106 to the delivery zone 108, and may for example be located at position 110. Other trucks may have finished delivering loads of material 104 and be in transit from the delivery zone 108 back to the loading zone 106, and may for example be located at position 112.

Accordingly, individual machines 102 within a set of machines 102 that are performing the same work cycle may move along substantially the same route 114 through the worksite 100 as they perform and transition between different segments of the work cycle. Additionally, the individual machines 102 may perform substantially the same operations as other machines 102 in the set when the machines 102 are at the same or similar locations along a route 114 through the worksite 100. As an example, when a work cycle involves dump trucks moving from a loading zone 106 to a delivery zone 108, each dump truck may be likely to perform the same or similar operations associated with dumping material 104 when they reach the delivery zone 108, even though individual dump trucks may arrive at the delivery zone 108 at different times.

In some examples, the location and boundaries of different zones within a worksite 100, such as loading zones 106 or delivery zones 108, and/or the location and boundaries of the worksite 100 itself, may change over time. For instance, the location and boundaries of a worksite 100 for a road construction project may change over time as portions of a roadway are completed and work activity moves to unfinished portions of the roadway. Similarly, the location of a loading zone 106 within a worksite 100 may change as work progresses, and/or the locations of delivery zones 108 may change as work progresses when material 104 is no longer needed at some portions of the worksite 100 but becomes needed at other portions of the worksite 100. Accordingly, overall a worksite 100 may be a dynamic worksite 100 with elements that change week-by-week, day-by-day, minute-by-minute, or on any other schedule.

In some examples, geofences 116 and/or other location data can be used to define the locations or boundaries of an overall worksite 100 and/or zones within the worksite 100. For example, geofence 116 data can express coordinates, such as GPS coordinates, latitude and longitude coordinates, or other types of coordinates, or other location data that express or define the location or boundaries of a worksite 100, the location or boundaries of loading zones 106, the location or boundaries of delivery zones 108, or the location or boundaries of any other zone or area associated with a worksite 100. In some examples, a geofence 116 can be centered around a machine 102. For example, a geofence 116 may define, boundaries of a loading zone 106 or delivery zone 108 that is centered relative to a particular machine 102 that loads or unloads material 104 in the corresponding zone. As another example, a geofence 116 may define an area within a threshold distance away from a machine 102, and accordingly in some cases may move along with the machine 102 as the machine 102 moves around the worksite 100. In some examples, such geofences 116 or other location data can define exclusion areas that are not considered active work areas within the worksite 100, such as parking lots, restrooms, and designated break or lunch areas.

In some examples, geofences 116 or other location data associated with boundaries and/or locations of a worksite 100, and/or zones of the worksite 100, can be defined by a foreman or other human operator. However, in other examples, such geofences 116 or other location data associated with a worksite 100, and/or zones of the worksite 100, can be defined or updated automatically based on data reported by machines 102, as will be described in more detail below.

In some examples, machines 102 on a worksite 100 may communicate via a network 118 with an off-board computing system 120, such as a computer, server, or other computing element that may be located apart from the machines 102. For example, the network 118 can be a cellular network, Wi-Fi® network, or any other type of network. In some examples, machines 102 can use the network 118 to report location data and/or other types of data to the off-board computing system 120, such that the off-board computing system 120 can track locations of the machines 102 on the worksite using reported location data. Interactions between the machines 102 on a worksite and an off-board computing system 120 are discussed in more detail below.

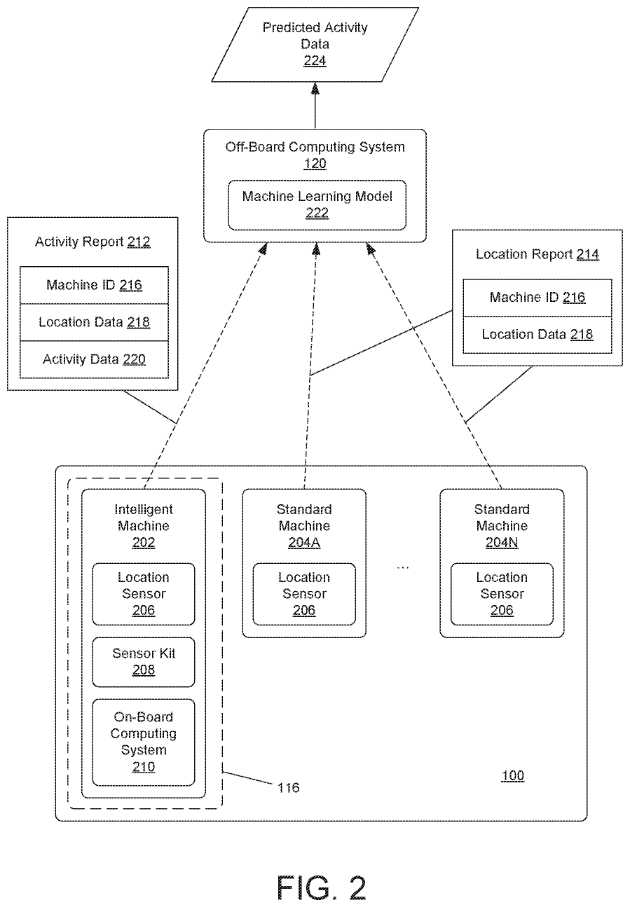

FIG. 2 depicts an example of an intelligent machine 202 and one or more standard machines 204 on a worksite 100 communicating with an off-board computing system 120. As described above, multiple machines 102 can be deployed on a worksite 100. At least one of the machines 102 on the worksite 100 can be an intelligent machine 202, while the other machines 102 can be standard machines 204.

In some examples, the intelligent machine 202 and the standard machines 204 can be machines 102 of the same or a similar type. For example, the intelligent machine 202 and the standard machines 204 can all be trucks that follow the same work cycle to transport material 104 from loading zones 106 to delivery zones 108, as shown in the example of FIG. 1. In other examples, one or more intelligent machines 202 can be a different type of machine 102 than the standard machines 204. For example, the intelligent machine 202 can be an excavator or other loader that loads material 104 onto trucks at a loading zone 106 and/or that unloads material 104 from trucks at a delivery zone 108. In this example, the standard machines 204 can be a set of trucks that move the material 104 from the loading zone 106 to the delivery zone 108 according to the same work cycle. In some examples, an intelligent machine 202 may be present at a loading zone 106 and another intelligent machine 202 can be present at a delivery zone 108, while the same or different types of standard machines 204 move between the loading zone 106 and the delivery zone 108.

The intelligent machine 202 and individual standard machines 204 can each have a location sensor 206 configured to determine and/or track the location of the corresponding machine 102. In some examples, a location sensor 206 can be a GPS sensor. In other examples, a location sensor 206 can be a proximity sensor or other type of sensor that determines a machine's location based on its position relative to beacons or other markers positioned around a worksite 100. In still other examples, a location sensor 206 can determine a location of a machine 102 based on cellular triangulation with cell towers, or can comprise any other type of location and/or positional sensor.

The intelligent machine 202 can also include sensor kit 208 that includes several other sensors in addition to the location sensor 206. The sensors in the sensor kit 208 can include one or more types of sensors installed in and/or around the intelligent machine 202 to measure or determine telematics data and/or other operational and/or machine state parameters, including parameters that have values that may change over time as the intelligent machine 202 performs work tasks. Sensors in the sensor kit 208 may include load sensors configured to detect load levels on the intelligent machine 202 overall, or on individual components of the intelligent machine 202. Sensors in the sensor kit 208 may also, or alternately, measure or detect pressures associated with pumps, hydraulic cylinders, or other machine components. Sensors in the sensor kit 208 may also, or alternately, measure or detect positions of machine components over time, such as by detecting positional data about components in three-dimensional space. For instance, a positional sensor can be an accelerometer, an inertial measurement unit (IMU), a string potentiometer, displacement sensor, or other type of sensor that can measure or determine height and/or other positional data about booms, sticks, buckets, blades, cylinders, implements, and/or other machine components. Sensors in the sensor kit 208 can also, or alternately, measure engine revolutions per minute, fuel levels and/or fuel consumption rates, and/or any other type of operational, machine state, or telematics data.

Accordingly, the sensor kit 208 can include one or more types of sensors that can provide measurements or other data, from which telematics data and/or other operational and/or machine state parameters can be determined. In some examples, data from one type of sensor in the sensor kit can be used to derive other types of information. For example, changes in fuel consumption rates or fuel levels over time, as measured by one or more sensors in the sensor kit 208, can be used to sense that machine components are moving or have moved, as will be discussed further below.

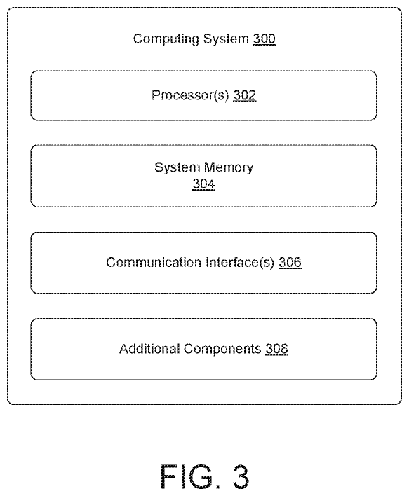

The intelligent machine 202 can also include an on-board computing system 210. An example system architecture for a computing system, such as the on-board computing system 210, is illustrated in greater detail in FIG. 3, and is described in detail below with reference to that figure.

The on-board computing system 210 can be configured to execute one or more algorithms to, based on sensor data provided by the sensor kit 208, locally identify and/or classify activities that are being, or have been, performed by the intelligent machine 202. For example, an on-board computing system 210 of a dump truck can be configured to, using positional data from sensors indicating that the dump truck's dump body was angled, and/or load level data from sensors indicating that load levels on the dump truck decreased, determine that the dump truck performed an unloading operation to dump material 104 from the dump body. As another example, an on-board computing system 210 of a wheel tractor scraper can be configured to use sensor data from a sensor kit 208 installed on the wheel tractor scraper to detect when the wheel tractor scraper is or was performing loading activities, dumping activities, transit activities, or other types of activities. Further examples of an intelligent machine 202 using on-board processing, based on sensor data from sensors in a sensor kit 208, to identify and/or classify the activities performed by that intelligent machine 202 are described in more detail in U.S. Pat. Nos. 5,955,706 and 8,660,738, both of which are incorporated herein by reference.

In some examples, the on-board computing system 210 can use sensor data from the sensor kit 208 to identify when the intelligent machines 102 performed activities associated with individual segments of a larger work cycle. For instance, the on-board computing system 210 can use sensor data from the sensor kit 208 to determine when the intelligent machine 202 was performing loading segments, loaded transit segments, unloading segments, and/or unloaded transit segments of the example work cycle discussed above with respect to FIG. 1. As an example, when load levels and/or fuel consumption rates provided by sensors of the sensor kits 208 increase suddenly from previous values, the on-board computing system 210 may determine that the intelligent machine 202 performed a loading segment of a work cycle because the increased load levels and/or fuel consumption rates correspond to load levels and/or fuel consumption rates that generally occur when the intelligent machine 202 has picked up material 104.

As shown in FIG. 2, the intelligent machines 202 and the standard machines 204 can send reports, such as activity reports 212 and location reports 214, to an off-board computing system 120. In particular, an intelligent machine 202 can sent an activity report 212 to the off-board computing system 120, while the standard machines 204 can send location reports 214 to the off-board computing system 120. In some examples, the activity reports 212 and location reports 214 can be sent to the off-board computing system 120 over a network 118 by the intelligent machines 202 and the standard machines 204, for example as digital files and/or as signals or other information represented in data packets that can be sent over the network 118.

The off-board computing system 120 can be a server, desktop computer, laptop computer, or any other computing device. In various examples, the off-board computing system 120 may be located in an office or other location away from the worksite 100, be located at the worksite 100 apart from the machines 102, be located in a server farm, be a cloud element of a cloud computing environment, or be at any other location apart from the machines 102. An example system architecture for a computing system, such as the off-board computing system 120, is illustrated in greater detail in FIG. 3, and is described in detail below with reference to that figure.

In some examples, the intelligent machines 202 and/or the standard machines 204 can have wireless communication components, such as modems, transceivers, and/or other elements, through which the machines 102 can wirelessly send their reports to the off-board computing system 120. For example, the intelligent machines 202 and/or the standard machines 204 can have cellular components, Wi-Fi® components, Bluetooth® components, and/or any other components for sending and/or receiving data wirelessly. In other examples, the reports can be transferred from the intelligent machines 202 and/or the standard machines 204 to the off-board computing system 120 using wired connections, such as Ethernet or other direct data connections, be transferred from the intelligent machines 202 and/or the standard machines 204 to memory cards or other memory devices before being loaded to the off-board computing system 120, or otherwise be transferred from the intelligent machines 202 and/or the standard machines 204 to the off-board computing system 120.

In some examples, the intelligent machines 202 and the standard machines 204 can each directly submit their reports to the off-board computing system 120. In other examples, the standard machines 204 can submit their location reports 214 to an intelligent machine 202 via wired or wireless connections, and the intelligent machine 202 can in turn provide its activity report 212 and the location reports 214 from the standard machines 204 to the off-board computing system 120. In other examples, reports from the intelligent machine 202 and/or standard machines 204 can initially be sent to one or more intermediate computing devices and/or be stored in databases or other memory locations, such that the reports can later be provided by such elements to the off-board computing system 120 for further processing.

Activity reports 212 submitted by the intelligent machine 202 can include at least one machine identifier 216 associated with the intelligent machine 202, such as a name, number, and/or other value that uniquely identifies the intelligent machine 202. In some examples, the machine identifier 216, or other information in an activity report 212, may also identify a type of the intelligent machine 202.

The activity reports 212 sent by the intelligent machine 202 can also include location data 218 determined by the location sensor 206 of the intelligent machine 202. The location data 218 can be indexed by time, such that the location data 218 indicates coordinates or other positional data about the intelligent machine 202 at one or more points in time, for example as the intelligent machine 202 moved around the worksite 100 while performing tasks associated with a work cycle and/or other tasks. In some examples, the location data 218 corresponding to different points in time can be used to determine where the intelligent machine 202 was on the worksite 100 at a certain point in time, can be averaged or otherwise processed to determine a speed at which the intelligent machine 202 was moving, whether the intelligent machine 202 was performing work tasks on schedule, behind schedule, or ahead of schedule, and/or can be used to track the intelligent machine 202 or derive any other information about the intelligent machine 202 based on changes in its location over time.

The activity reports 212 submitted by the intelligent machine 202 can further include activity data 220 that identifies activities performed by the intelligent machine 202 over time. The activity data 220 can have been locally determined by the on-board computing system 210 of the intelligent machine 202, based at least in part on sensor data from the sensor kit 208, as discussed above. The activity data 220 provided in the activity reports 212 can be indexed by time, such that the activity reports 212 indicate times at which the intelligent machine 202 was engaged in the activities identified in the activity data 220. Accordingly, the time-indexed activity data 220 can be correlated with the time-indexed location data 218 in the activity reports 212 submitted by the intelligent machine 202. For example, activity reports 212 from the intelligent machine 202 can indicate, for multiple points in time, both locations where the intelligent machine 202 was on the worksite 100 and what activities the intelligent machine 202 was performing at those locations. In alternate examples, the intelligent machine 202 may include time-indexed sensor data from the sensor kit 208 in the activity reports 212 sent to the off-board computing system 120 instead of, or in addition to, activity data 220, and the off-board computing system 120 can be configured to determine time-indexed activity data 220 about the intelligent machine 202 based on the sensor data provided in the activity reports 212.

Additionally, as shown in FIG. 2, the standard machines 204 can submit location reports 214 to the off-board computing system 120. The location reports 214 from the standard machines 204 can include machine identifiers 216 that uniquely identify the standard machines 204 and/or types of the standard machines 204, similar to the activity reports 212 from the intelligent machines 202. The location reports 214 from the standard machines 204 can also include time-indexed location data 218 determined by location sensors 206 of the standard machines 204, similar to the activity reports 212 from the intelligent machines 202. However, the standard machines 204 may be configured not to, or be unable to, include activity data 220 or corresponding sensor data about the standard machines 204 in reports to the off-board computing system 120. Accordingly, the location reports 214 from the standard machines 204 may include machine identifiers 216 and location data 218, but lack activity data 220 or corresponding sensor data about the standard machines 204.

As an example, a standard machine 204 may not have a sensor kit 208 and/or an on-board computing system 210 that is configured to locally identify or classify activities of the standard machine 204 based on sensor data. Accordingly, the standard machine 204 may be unable to include activity data 220 and/or sensor data about the standard machine 204 in reports sent to the off-board computing system 120, due to the lack of a sensor kit 208 and/or an on-board computing system 210.

In some examples, a standard machine 204 may have some types of on-board computing systems 210 and/or one or more sensors of a sensor kit 208, similar to an intelligent machine 202. However, the standard machine 204 may nevertheless be configured not to submit activity data 220 and/or sensor data in location reports 214 sent to the off-board computing system 120. For example, standard machines 204 may be autonomous or semi-autonomous machines that operate at least in part based on sensor data and/or on-board processing. However, such on-board processing may be configured to drive operations and functions of the standard machine 204, but may not be configured to analyze sensor data to locally classify or identify activities that are, or were, being performed by the standard machine 204 as described above. Accordingly, even if such machines 102 have on-board processing and/or may be considered “intelligent” in some respects, they can be considered standard machines 204 as that term is used herein when they are not configured to derive and send activity data 220 or corresponding sensor data in location reports 214 to the off-board computing system 120.

In still other examples, machines 102 on a worksite 100 may include a number of machines 102 that have sensor kits 208 and on-board computing systems 210 configured to locally derive activity data 220 from sensor data. However, in such examples, a subset of one or more of the machines 102 can be designated as intelligent machines 202 that are configured to submit locally-derived activity data 220 in activity reports 212 to the off-board computing system 120, while the remainder of the machines 102 can be designated as standard machines 204 that are instead configured to send location reports 214 to the off-board computing system 120 that omit activity data 220.

The off-board computing system 120 can use activity reports 212 submitted by one or more intelligent machines 202 on a worksite 100 to train a machine learning model 222 to generate and output predicted activity data 224 for a machine 102 based on location data 218 about that machine 102. In some examples, the machine learning model 222 can be based on a recurrent neural network or other type of neural network, regression analysis, decision trees, and/or other types of artificial intelligence or machine learning frameworks.

For example, the off-board computing system 120 can use supervised machine learning to train the machine learning model 222 using time-indexed location data 218 as labeled by corresponding time-indexed activity data 220 provided in activity reports 212 from one or more intelligent machines 202 on a worksite 100. In some examples, the machine learning model 222 can be trained until the machine learning model 222 can use location data 218 in activity reports 212 from an intelligent machine 202 to generate predicted activity data 224 that matches the activity data 220 in the activity reports 212 to at least a threshold degree of similarity. For example, when an activity report 212 indicates that an intelligent machine 202 was performing a particular segment of a work cycle at a particular time at a particular location on a worksite 100, the off-board computing system 120 can train the machine learning model 222 until the machine learning model 222 can take location data 218 associated with that particular location as an input and accurately generate an output indicating that the particular segment of a work cycle was being performed at the particular location.

Once the off-board computing system 120 has trained the machine learning model 222 using activity reports 212 submitted by the intelligent machine 202, the off-board computing system 120 can apply the machine learning model 222 to data in location reports 214 submitted by standard machines 204 to generate predicted activity data 224. For example, the machine learning model 222 can use location data 218 in location reports 214 from standard machines 204 to generate predicted activity data 224 about tasks and/or activities the standard machines 204 are inferred to have performed while the standard machines 204 were at different locations on the worksite 100. The predicted activity data 224 can be stored on the off-board computing system 120, be displayed in a user interface by the off-board computing system 120, be transferred to a user device or other computing device, be used to analyze activity that has or is occurring on the worksite 100, and/or be used in any other way.

The machine learning model 222, once trained, may generate predicted activity data 224 for standard machines 204 based on location data 218 in location reports 214 from the standard machines 204, despite the absence of activity data 220 in the location reports 214 from the standard machines 204. The machine learning model 222 can take location data 218 associated with a period of time from a location report 214 submitted by a standard machine 204 and generate and output predicted activity data 224 including a prediction of what the standard machine 204 was doing during that period of time. For example, even though a standard machine 204 may not have a load sensor or other sensors of a sensor kit 208, the off-board computing system 120 may nevertheless use the machine learning model 222 to infer that the standard machine 204 likely experienced certain loads and/or performed certain tasks or actions when the standard machine 204 was located at certain positions of a worksite 100. Accordingly, the off-board computing system 120 can use the machine learning model 222 to infer activities performed by one or more standard machines 204 on a worksite 100, even if those standard machines 204 are not outfitted with a sensor kit 208 and/or are not configured to identify or classify their own activities.

As an example, activity reports 212 from an intelligent machine 202 may include activity data 220 indicating that the intelligent machine 202 performed a loading segment of a work cycle at a particular loading zone 106 on a worksite 100. In this example, the machine learning model 222 may generate and output predicted activity data 224 indicating that a standard machine 204 of the same type as the intelligent machine 202 likely also performed the loading segment of the work cycle when the standard machine 204 itself moved to that particular loading zone 106 of the worksite 100.

As another example, activity reports 212 from an intelligent machine 202 may include location data 218 and activity data 220 indicating that the intelligent machine 202 remained at one location on a worksite 100, but loaded or unloaded material 104 at that location for other standard machines 204 that moved around the worksite to transport the material 104 to or from other locations. In this example, the machine learning model 222 can determine from the activity data 220 of the stationary intelligent machine 202 that certain areas of the worksite 100 are loading zones 106 or delivery zones 108. The machine learning model 222 can in turn use location data 218 in location reports 214 from the standard machines 204 to generate predicted activity data 224 indicating that the standard machines 204 likely performed loading or unloading activities when they were located at those loading zones 106 or delivery zones 108, and likely performed transit activities when they were moving between the loading zones 106 and delivery zones 108.

In some examples, the predicted activity data 224 can include predicted load levels and/or other machine state parameters or telematics data associated with activities the machine learning model 222 predicts the standard machines 204 performed. For example, if the activity data 220 or corresponding sensor data in activity reports 212 from an intelligent machine 202 indicates that the intelligent machine 202 experienced certain load levels and/or moved a certain volume of material 104 when the intelligent machine 202 performed particular activities at particular locations, the predicted activity data 224 for the standard machines 204 can indicate that the standard machines 204 are inferred to have experienced the same or similar load levels and/or moved the same or similar volume of material 104 when the standard machines 204 are predicted to have performed particular activities at the particular locations. As another example, if the location data 218 and activity data 220 from a stationary intelligent machine 202 indicates that the intelligent machine 202 loaded a certain volume or weight of material 104 onto standard machines 204 at a particular location, the predicted activity data 224 can indicate that the standard machines 204 are inferred to have received that volume or weight of material 104, and/or incurred corresponding load levels and other corresponding changes to machine state parameters, when performing activities at the particular location.

Accordingly, the off-board computing system 120 can be configured to track estimated load levels and other telematics data about a set of a machines 102 on a worksite 100 over time. For example, such estimated load levels and/or telematics data can be based on activity data 220 or corresponding sensor data reported directly by intelligent machines 202, as well as based on predicted activity data 224 about standard machines 204 generated by the machine learning model 222. Similarly, the off-board computing system 120 can be configured to track movements of material 104 on a worksite 100 over time. For example, material tracking can be based on movement of material 104 indicated by activity data 220 or corresponding sensor data reported directly by intelligent machines 202, and/or on indications of inferred movement of material 104 in predicted activity data 224 about standard machines 204 generated by the machine learning model 222.

Additionally, in some examples, when geofence 116 data or other location data has been defined for the location and/or boundaries of a worksite 100, and/or individual zones or exclusion zones of the worksite 100, the off-board computing system 120 can use that data to determine whether the machines 102 were within such locations or boundaries when they performed certain tasks. As an example, the off-board computing system 120 can compare location data 218 in activity reports 212 from an intelligent machine 202 against previously-defined geofence 116 data or other location data corresponding to the worksite 100 to determine if the intelligent machine 202 was in previously-defined boundaries of the worksite 100 or a worksite zone when the intelligent machine 202 performed certain tasks identified in activity data 220. As another example, the off-board computing system 120 can use location data 218 in location reports 214 from a standard machine 204 to determine if the standard machine 204 was in previously-defined boundaries of the worksite 100 or a worksite zone when predicted activity data 224 indicates that the standard machine 204 are inferred to have performed certain tasks. Accordingly, the off-board computing system 120 can determine whether machines 102, based on location data 218 and reported activity data 220 or predicted activity data 224, were within the boundaries of the worksite 100 when the machines 102 performed certain tasks, and/or whether the machines 102 were within the boundaries of loading zones 106, delivery zones 108, exclusion zones, or other zones of the worksite 100 when the machines 102 performed certain tasks.

In some examples, if the location data 218, activity data 220, and/or predicted activity data 224 indicates that machines 102 performed work tasks outside the currently defined boundaries of the worksite 100, or outside currently defined zones of the worksite 100 that correspond to those work tasks, the off-board computing system 120 can automatically update, or recommend updates to, geofence 116 data or other location data associated with the worksite 100 and/or zones or the worksite 100. As an example, if the off-board computing system 120 determines that machines 102 are unloading material 104 at a location not currently associated with a delivery zone 108, the off-board computing system 120 may determine that that location is a delivery zone 108 and generate a new geofence 116 defining that location as a delivery zone 108. As another example, if reported or inferred activity data over time indicates that machines 102 were delivering material 104 to a first location but have since shifted to delivering material 104 to a second location that is twenty meters away from the first location, the off-board computing system 120 can determine that a delivery zone 108 has moved from the first location to the second location. In this example, the off-board computing system 120 can automatically update, or recommend an update to, a geofence 116 associated with the delivery zone 108 to reflect the second location instead of the first location.

In some examples, if reported location data 218 about an intelligent machine 202 indicates that the intelligent machine 202 was in an exclusion zone, such as a parking lot or break area, the off-board computing system 120 can be configured to not consider the location data 218 or corresponding activity data 220 when training the machine learning model 222. Similarly, if reported location data 218 about a standard machine 204 indicates that the standard machine 204 was in an exclusion zone, the off-board computing system 120 can be configured to not generate predicted activity data 224 corresponding to that location data 218.

In some examples, the off-board computing system 120 may continue to receive subsequent activity reports 212 from the intelligent machine 202 after the machine learning model 222 has initially been trained and may have begun producing predicted activity data 224 about standard machines 204. In these examples, the off-board computing system 120 may use the subsequent activity reports 212 to update and/or further train the machine learning model 222. For example, if the intelligent machine 202 begins new work tasks or adjusts activities it performs as part of a work cycle, which may indicate changes that standard machines 204 may also be following, the off-board computing system 120 can train and/or update the machine learning model 222 to produce predicted activity data 224 based on such new or adjusted work tasks as identified in subsequent activity reports 212 from the intelligent machine 202.

FIG. 3 depicts an example system architecture for a computing system 300. In various examples, the computing system 300 can be the on-board computing system 210 or the off-board computing system 120 described above. The computing system 300 can include one or more computing devices or other controllers that include one or more processors 302, system memory 304, and communication interfaces 306. In some examples in which the computing system 300 is an on-board computing system 210, the computing system 300 can be, or include, an electronic control module (ECM) for a machine 102, a programmable logic controller (PLC), and/or other computing devices. In other examples in which the computing system 300 is an off-board computing system 120, the computing system 300 can be, or include, one or more laptop computers, desktop computers, servers, cloud computing elements, or any other type computing device.

The processor(s) 302 may operate to perform a variety of functions as set forth herein. In some examples, the processor(s) 302 may include a central processing unit (CPU), a graphics processing unit (GPU), both CPU and GPU, or other processing units or components known in the art.

System memory 304 can be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that can be executed by the processor(s) 302 to perform the operations described herein.

For example, the system memory 304 can include a drive unit and/or other elements that include machine-readable media. A machine-readable medium can store one or more sets of instructions, such as software or firmware, that embodies any one or more of the methodologies or functions described herein. The instructions can also reside, completely or at least partially, within the processor(s) 302 and/or communication interface(s) 306 during execution thereof by the computing system 300. For example, the processor(s) 302 may possess local memory, which also may store program modules, program data, and/or one or more operating systems. The system memory 304 may also store other modules and data that can be utilized by the computing system 300 to perform or enable performing any action taken by the computing system 300. The modules and data can include a platform, operating system, and/or applications, as well as data utilized by the platform, operating system, and/or applications.

In embodiments in which the computing system 300 is an on-board computing system 210 of an intelligent machine 202, the system memory 304 can store location data provided by the location sensor 206 and sensor data from the sensor kit 208. The system memory 304 can also store computer-executable instructions that the processors 302 can use to locally determine activity data 220 based on the sensor data, and to generate activity reports 212 including a machine identifier 216, location data 218, and the activity data 220.

In embodiments in which the computing system 300 is an off-board computing system 120, the system memory 304 can store activity reports 212 received from one or more intelligent machines 202 and location reports 214 received from one or more standard machines 204. The system memory 304 can also store the machine learning model 222, as well as computer-executable instructions that the processors 302 can use to train the machine learning model 222 and/or execute the machine learning model 222 to generate predicted activity data 224. In some examples, the system memory 304 can also store geofence 116 data and/or other location data about the location or boundaries of a worksite 100 and/or zones of the worksite 100.

The communication interfaces 306 can include transceivers, modems, interfaces, antennas, and/or other components that can transmit and/or receive data over networks 118 or other data connections. For example, in embodiments in which the computing system 300 is an on-board computing system 210 of an intelligent machine 202, the communication interfaces 306 can transmit activity reports 212 to the off-board computing system 120. As another example, in embodiments in which the computing system 300 is an off-board computing system 120, the communication interfaces 306 can receive activity reports 212 from intelligent machines 202 and location reports 214 from standard machines 204, and/or transmit predicted activity data 224 to a recipient device, such as a server or user device.

In some examples, the computing system 300 may include other additional components 308, such as a display, input devices, and/or output devices. For example, a display can be a liquid crystal display or any other type of display or screen. In some examples, a display may be a touch-sensitive display screen, and can then also act as an input device or keypad, such as for providing a soft-key keyboard, navigation buttons, or any other type of input. Input devices can include any type of input device, such as a microphone, a keyboard/keypad, and/or a touch-sensitive display. A keyboard/keypad can be a push button numeric dialing pad, a multi-key keyboard, or one or more other types of keys or buttons, and can also include a joystick-like controller, designated navigation buttons, or any other type of input mechanism. Output devices can include any type of output device, such as a display, speakers, a vibrating mechanism, and/or a tactile feedback mechanism. Output devices can also include ports for one or more peripheral devices, such as headphones, peripheral speakers, and/or a peripheral display.

In some examples, predicted activity data 224 generated by the off-board computing system 120 can be presented via a display and/or output device of the off-board computing system 120. In other examples, predicted activity data 224 generated by the off-board computing system 120 can also, or additionally, be stored in system memory 304 of the off-board computing system 120, and/or be transferred to a user device or another computing device via communication interfaces 306 of the off-board computing system 120.

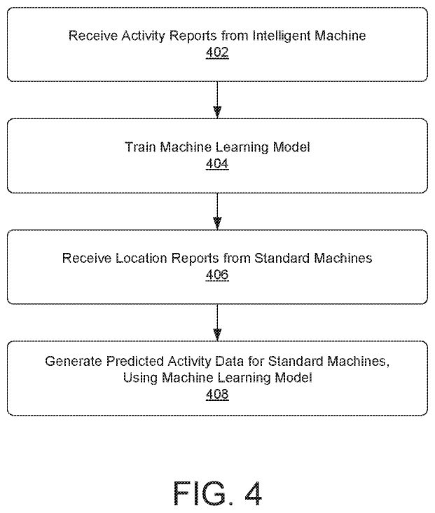

FIG. 4 is a flowchart illustrating a method 400 for training and using a machine learning model to generate predicted activity data 224. The method is illustrated as a logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. Additionally, although the method of FIG. 4 is described below with respect to an off-board computing system 120, in other examples any or all of the operations described with respect to FIG. 4 can be performed by an on-board computing system 210 or any other type of computing system 300.

At block 402, an off-board computing system 120 can receive one or more activity reports 212 from one or more intelligent machines 202 on a worksite 100. The activity reports 212 from the intelligent machines 202 can include machine identifiers 216, location data 218, and activity data 220.

At block 404, the off-board computing system 120 can train a machine learning model 222, such as a recurrent neural network, based on the location data 218 and activity data 220 in the activity reports 212 received during block 402. In some examples, the off-board computing system 120 can train the machine learning model 222 until the machine learning model can use the location data 218 to predict corresponding activity data 220 to at least a threshold degree of accuracy. For example, if the machine learning model 222 generates predicted activity data 224 that does not match the activity data 220 included in activity reports 212 received at block 402, the off-board computing system 120 may continue training the machine learning model 222 or wait for additional activity reports 212 to be received at block 402 to further train the machine learning model 222 using the additional activity reports 212.

At block 406, the off-board computing system 120 can receive one or more location reports 214 from one or more standard machines 204 on the worksite 100. The location reports 214 from the standard machines 204 can include machine identifiers 216 and location data 218, but may lack activity data 220.

At block 408, the off-board computing system 120 can generate predicted activity data 224 for the standard machines 204 by applying the machine learning model 222 to the location data 218 in the location reports 214 from the standard machines 204. The machine learning model 222 can generate and/or output predicted activity data 224 that indicates activities the standard machines 204 are inferred to have performed when the standard machines 204 were located at corresponding locations on the worksite 100.

### INDUSTRIAL APPLICABILITY

The systems and methods described herein can be used to use location data 218 of standard machines on a worksite 100 to generate predicted activity data 224 about activities the standard machines 204 are inferred to have performed on the worksite 100. For example, the predicted activity data 224 about inferred activities of standard machines 204 can be generated even when the standard machines 204 do not have sensors of a sensor kit 208 that can provide sensor data that may indicate what activities the standard machines 204 performed. The predicted activity data 224 can be generated by a machine learning model 222 trained using location data 218 and activity data 220 reported by one or more intelligent machines 202 that do have a sensor kit 208, and/or an on-board computing system 210 configured to locally determine activity data 220 of the intelligent machines 202 from sensor data.

Because the machine learning model 222 can generate predicted activity data 224 about standard machines 204 based on location data 218 of the standard machines 102, the standard machines 204 can lack the sensor kit 208 and/or on-board computing system 210 of the intelligent machine 202. Accordingly, costs and maintenance needs associated with machines 102 of a worksite 100 can be decreased by not providing every machine 102 on the worksite 100 with a sensor kit 208 and an on-board computing system 210. However, even though such costs and maintenance needs can be decreased by only having one or more intelligent machine 202 within an overall set of machines 102, the predicted activity data 224 about the standard machines 204 can nevertheless allow activities of both the intelligent machines 202 and the standard machines 204 on the worksite 100 to be determined and/or tracked over time.

For example, predicted activity data 224 about a standard machine 204 may indicate that the standard machine 204 has performed one thousand iterations of a work task over time, and aggregated load levels on a component of the standard machine 204 across those iterations may indicate that the component is due for replacement or inspection. Accordingly, even though the standard machine 204 may not have sensors that directly indicates such load levels, the predicted activity data 224 can nevertheless be used to flag when such a replacement or inspection should be performed.

As another example, predicted activity data 224 about one or more standard machines 204, in some cases combined with reported activity data 220 from intelligent machines 202, may indicate that a certain volume of material 104 has been moved from one location to another on a worksite 100. For instance, if predicted activity data 224 indicates that standard machines 204 are inferred to have moved a certain volume of material 104 from a loading zone 106 to a delivery zone 108 during each iteration of a work cycle, and a number of complete work cycles have been performed by the standard machines 204, the off-board computing system 120 can in turn multiply those values to calculate how much material 104 the standard machines 204 have moved overall. This can be useful for worksite 100 diagnostics and/or analytics, for example to verify that an amount of material 104 that was expected during a design phase to be moved during a project has been moved, or to determine whether a particular standard machine 204 is likely to have moved an assigned amount of material 104 and can now move to a next task on a task list.

Predicted activity data 224 that indicates what activities standard machines 204 likely performed, and/or that tracks movement of material 104 can also be used to generate recommendations about a worksite 100. For example, if such data indicates that material 104 is not being moved quickly enough to meet a desired schedule, or that material 104 is being moved ahead of schedule, the off-board computing system 120 may recommend that machines 102 be added or removed from the worksite 100.

Predicted activity data 224 can also be used to retroactivity identify or move geofenced areas of a worksite 100. For example, if predicted activity data 224 indicates that standard machines 204 performed unloading segments of a work cycle at a new location on a worksite 100, the off-board computing system 120 may determine that the new location should be designated as a delivery zone 108 and can generate new geofence 116 data for that new delivery zone 108. Similarly, if predicted activity data 224 indicates that standard machines 102 were performing unloading segments of a work cycle at a defined delivery zone 108, but then began performing the unloading segments at a new location just outside the defined delivery zone 108, the off-board computing system 120 may determine that the delivery zone 108 has moved and can correspondingly update geofence 116 data for the moved delivery zone 108. In situations in which aspects of a worksite 100 may be changing rapidly, even on a minute-by-minute basis, such automatic geofence updating can reduce the responsibility of a foreman or other human operator to keep worksite geofences 116 updated. As discussed above, because the predicted activity data 224 can be generated for standard machines 102 that may lack a sensor kit, such automatic geofence updating can be achieved even without having a sensor kit 208 for every machine 102 on the worksite 100.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A system, comprising:
an intelligent machine at a worksite, the intelligent machine comprising a first location sensor and a sensor kit,
at least one standard machine at the worksite, the at least one standard machine comprising a second location sensor; and
an off-board computing system configured to:
receive an activity report associated with the intelligent machine, the activity report comprising first location data from the first location sensor and activity data based on sensor data from the sensor kit;
train a machine learning model based on the first location data and the activity data;
receive at least one location report associated with the at least one standard machine, the at least one location report comprising second location data from the second location sensor; and
generate, using the machine learning model and based on the second location data, predicted activity data corresponding to the at least one standard machine, the predicted activity data identifying at least one predicted activity of the at least one standard machine.

2. The system of claim 1, wherein the intelligent machine is configured to determine the activity data based on the sensor data, and to include the activity data in the activity report.

3. The system of claim 1, wherein the at least one predicted activity is one or more activities the at least one standard machine is inferred to have performed at one or more corresponding locations on the worksite identified in the second location data.

4. The system of claim 3, wherein the predicted activity data indicates inferred movement of material on the worksite by the at least one standard machine during the one or more activities.

5. The system of claim 3, wherein the one or more corresponding locations are associated with geofence data defining one or more areas of the worksite.

6. The system of claim 5, wherein the off-board computing system is configured to update the geofence data based on the predicted activity data.

7. The system of claim 1, wherein the activity data in the activity report identifies one or more segments of a work cycle performed by the intelligent machine.

8. The system of claim 1, wherein the intelligent machine and the at least one standard machine are a same type of machine.

9. A system, comprising:
one or more processors; and
memory storing computer-executable instructions that, when executed by the one or more processors, cause the one or more processors to perform operations comprising:
receiving an activity report comprising first location data and activity data about an intelligent machine on a worksite;
training a machine learning model based on the first location data and the activity data;
receiving one or more location reports comprising second location data about one or more standard machines on the worksite; and
generating, using the machine learning model and based on the second location data, predicted activity data corresponding to the one or more standard machines, the predicted activity data identifying at least one predicted activity of the one or more standard machines.

10. The system of claim 9, wherein the at least one predicted activity is one or more activities the one or more standard machines are inferred to have performed at one or more corresponding locations on the worksite identified in the second location data.

11. The system of claim 10, wherein the predicted activity data indicates inferred movement of material on the worksite by the one or more standard machines during the one or more activities.

12. The system of claim 10, wherein the one or more corresponding locations are associated with geofence data defining one or more areas of the worksite.

13. The system of claim 12, wherein the operations further comprise updating the geofence data based on the predicted activity data.

14. The system of claim 9, wherein the activity data in the activity report identifies one or more segments of a work cycle performed by the intelligent machine.

15. A method, comprising:
receiving, by a computing system, an activity report comprising first location data and activity data about an intelligent machine on a worksite;
training, by the computing system, a machine learning model based on the first location data and the activity data;
receiving, by the computing system, one or more location reports comprising second location data about one or more standard machines on the worksite; and
generating, by the computing system using the machine learning model and based on the second location data, predicted activity data corresponding to the one or more standard machines, the predicted activity data identifying at least one predicted activity of the one or more standard machines.

16. The method of claim 15, wherein the at least one predicted activity is one or more activities the one or more standard machines are inferred to have performed at one or more corresponding locations on the worksite identified in the second location data.

17. The method of claim 16, wherein the predicted activity data indicates inferred movement of material on the worksite by the one or more standard machines during the one or more activities.

18. The method of claim 16, wherein the one or more corresponding locations are associated with geofence data defining one or more areas of the worksite.

19. The method of claim 18, further comprising updating the geofence data based on the predicted activity data.

20. The method of claim 15, wherein the activity data in the activity report identifies one or more segments of a work cycle performed by the intelligent machine.
